(19) United States
(12) Patent Application Publication
(10) Pub. No.: US 2006/0190307 A1
(43) Pub. Date: Aug. 24, 2006

(54) Automated fulfillment system for optimizing web-based transactions

(76) Inventor: Jeffrey Palmer Maxwell, Brooklyn, NY (US)

Correspondence Address: VASANT V. CHAPHEKAR, 9104 CAIRA COVE, AUSTIN, TX, 78750, US

(21) Appl. No.: 11/358,872

(22) Filed: Feb. 21, 2006

Related U.S. Application Data
(60) Provisional application No. 60/655,092, filed on Feb. 22, 2005.

(51) Int. Cl. G06Q 99/00; G06Q 10/00; G01C 21/34; G01C 21/36

(52) U.S. Cl. 705/5; 705/1; 705/6

(57) ABSTRACT

In a method and system for providing travel fulfillment, a plurality of criteria for the travel fulfillment is received by a client from a user. Continual searches for the published prices fulfilling the plurality of prices are conducted concurrently during a time interval by the client and a server coupled to the client via a network. An optimum price satisfying at least one price criteria defined by the user is determined within the published prices. The optimum price is stored and an alert message is sent to the user advising about the travel fulfillment.

### CROSS REFERENCE TO RELATED APPLICATIONS

This application claims priority to a provisional application Ser. No. 60/655,092, filed Feb. 22, 2005. The provisional application is incorporated herein by reference as if the application was reproduced in its entirety herein.

### BACKGROUND

The present disclosure relates to the field of web-based transactions, and more particularly to systems and methods for providing optimal pricing for travel transactions conducted over computer networks.

As the value and use of information continues to increase, individuals and businesses seek additional ways to acquire, process and store information. One option available to users is information processing systems. An information processing system (‘IPS’) generally processes, compiles, stores, and/or communicates information or data for business, personal, or other purposes thereby allowing users to take advantage of the value of the information. Because technology and information processing needs and requirements vary between different users or applications, information processing systems may also vary regarding what information is handled, how the information is handled, how much information is processed, stored, or communicated, and how quickly and efficiently the information may be processed, stored, or communicated. The variations in information processing systems allow for information processing systems to be general or configured for a specific user or specific use such as financial transaction processing, insurance business management, travel reservations including airline, hotels and car rentals, enterprise data storage, entertainment, and/or global communications. In addition, information processing systems may include a variety of hardware and software components that may be configured to process, store, and communicate information and may include one or more computer systems, data storage systems, and networking systems.

Presently, some web based travel applications search for travel itineraries matching user requirements at a particular instant-in-time, e.g., when a query is made. Generalized low fare alerts sent by some travel related web sites may not be useful to make travel reservations for a specific event such as a wedding. Thus, many customers have to frequently search the plethora of travel related on-line web sites, servers and/or databases for possible transactions that optimally matched their travel itineraries and/or needs. This searching often required the dedication of the customer to the search process over the total time period needed to conduct the search and complete the transaction.

The process may be further complicated by the transient nature of the postings of the travel providers. Supplier offerings may often be exhausted (through prior purchase by other customers), may be changed at any time or may be withdrawn upon expiration of the offer period. Thus, a customer who may have located a favorable transaction but did not immediately make the purchase may be disappointed upon returning to the travel provider to find the desired reservation was no longer offered.

Therefore, a need exists to provide an improved method and system for providing travel fulfillment in accordance with specific user defined criteria. Accordingly, it would be desirable to provide a method and a travel fulfillment system for automatically providing optimally priced travel reservations, absent the disadvantages found in the prior methods discussed above.

### SUMMARY

The foregoing need is addressed by the teachings of the present disclosure, which relates to a system and method for providing travel fulfillment. According to one embodiment, in a method and system for providing travel fulfillment, a plurality of criteria for the travel fulfillment is received by a client from a user. Continual searches for the published prices fulfilling the plurality of prices are conducted concurrently during a time interval by the client and a server coupled to the client via a network. An optimum price satisfying at least one price criteria defined by the user is determined within the published prices. The optimum price is stored and an alert message is sent to the user advising about the travel fulfillment.

Several advantages are achieved by the method and system according to the illustrative embodiments presented herein. The embodiments advantageously provide for an improved technique to continually search the Internet by using two separate search engines to locate an optimum price for a user defined travel itinerary. In addition, the system is extensible thereby allowing for installed applications to modify their behavior based on data fed to the applications from the servers. Thus, the system is advantageously able to modify and adapt its behavior as the methods to query for travel inventory change over time.

### BRIEF DESCRIPTION OF THE DRAWINGS

FIG. 1A illustrates a block diagram of a system for insurance information processing (IIP), according to an embodiment;

FIG. 1B illustrates a block diagram of an information processing system (IPS), according to an embodiment;

FIG. 2 is a block diagram illustrating a travel fulfillment system, according to an embodiment; and

FIG. 3 is a flow chart illustrating a method for providing travel fulfillment, according to an embodiment.

### DETAILED DESCRIPTION

Novel features believed characteristic of the present disclosure are set forth in the appended claims. The disclosure itself, however, as well as a preferred mode of use, various objectives and advantages thereof, will best be understood by reference to the following detailed description of an illustrative embodiment when read in conjunction with the accompanying drawings. The functionality of various circuits, devices, boards, cards, modules, blocks, and/or components described herein may be implemented as hardware (including discrete components, integrated circuits and systems-on-a-chip ‘SOC’), firmware (including application specific integrated circuits and programmable chips) and/or software or a combination thereof, depending on the application requirements.

The following terminology may be useful in understanding the present disclosure. It is to be understood that the terminology described herein is for the purpose of description and should not be regarded as limiting.

Device—Any machine or component that is operable to perform at least one predefined function. Examples of devices used in an IPS include power supplies, fan assemblies, displays, controllers, disk drives, scanners, cameras, printers, speakers, keyboards, and communication interfaces. Many devices may require a software program called a device driver program that acts as a translator between an application program and the device, or between a user and the device.

System—One or more interdependent devices that co-operate to perform one or more predefined functions.

Configuration—Describes a set up of a device and/or a system and refers to a process for setting, defining, or selecting hardware and/or software properties, parameters, or attributes of the device and/or the system. Certain types of devices, systems and software applications may be automatically configured with initial default values, which may be changed by a user.

Client/Server—A form of distributed computing network architecture which distributes information technology functions such as storing, processing, and transmitting of data and/or information between a client computer and a server computer coupled by a network.

Web Services—Describe a standardized method of integrating web-based applications over the Internet. Specifically, a Web Service is an extensible markup language (XML) object comprised content, application code, code, process logic, or any combination thereof, that can be accessed over any TCTP/IP network using the SOAP standard for integration, the WSDL standard for self description, and the UDDI standard for registry and discovery within a public or private directory.

Fulfillment—Fulfillment is the accomplishment of a desired end result. Travel fulfillment refers to matching a travel provider capable of providing travel products and services to a consumer in accordance with certain consumer defined criteria.

For purposes of this disclosure, an IPS may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, the IPS may be a personal computer, including notebook computers, personal digital assistants, cellular phones, gaming consoles, a network storage device, or any other suitable device and may vary in size, shape, performance, functionality, and price. The information processing system may include random access memory (RAM), one or more processing resources such as central processing unit (CPU) or hardware or software control logic, ROM, and/or other types of nonvolatile memory. Additional components of the information processing system may include one or more disk drives, one or more network ports for communicating with external devices as well as various input and output (I/O) devices, such as a keyboard, a mouse, and a video display. The information processing system may also include one or more buses operable to receive/transmit communications between the various hardware components.

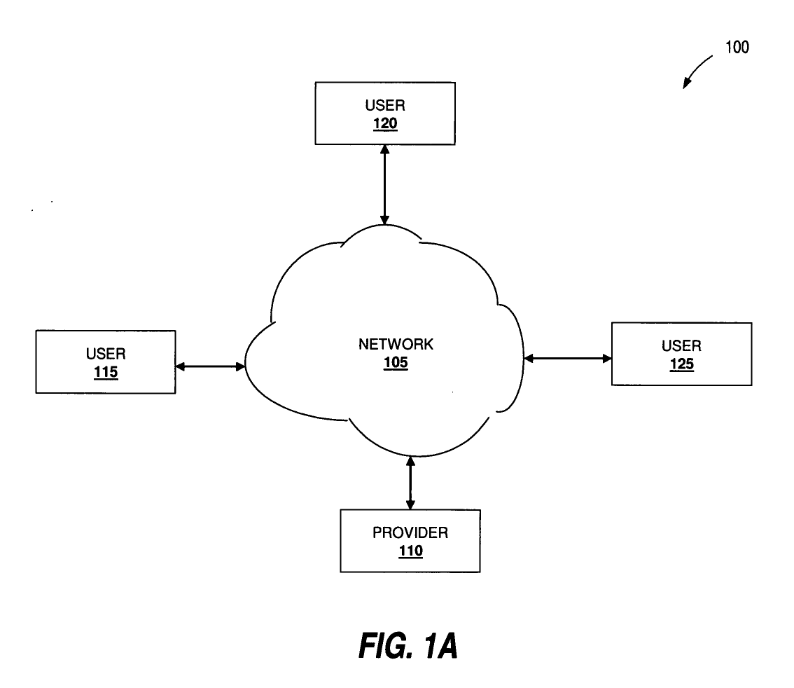

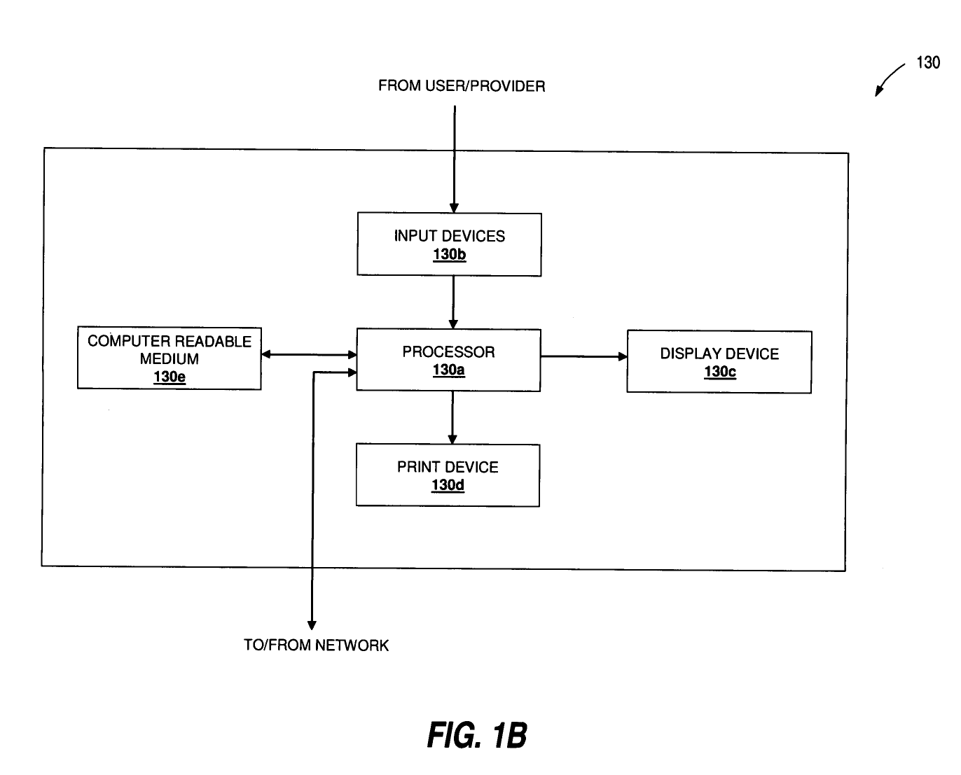

Referring now to FIG. 1A, a system for travel information processing (TIP) 100 is illustrated, according to an embodiment. The system 100 includes a computer network 105 such as, for example, an Ethernet Transport Control Protocol/Internet Protocol (TCP/IP) network (e.g., the Internet or an intranet) having a plurality of nodes. A travel provider 110 node is operably coupled to the network 105. Nodes for a plurality of users 115, 120, and 125 are also operably coupled to the network 105 in order to allow communication between the users 115,120, and 125 and the provider 110. Examples of a travel provider may include a business providing travel products and services such as an airline, a hotel, a car rental agency and a cruise operator, TripStalker—a web based travel provider, a travel insurance provider and similar others. Examples of a user may include a consumer, a traveler, a sales agent, a consultant, a researcher, and similar others.

Each of the provider 110 and the users 115, 120, and 125 includes a respective network interface for communicating with the network 105 (e.g., outputting information to, and receiving information from, the network 105), such as by transferring information (e.g., instructions, data, signals) between such users and the network 105. Accordingly, through the network 105, the provider 110 communicates with the users 115, 120, and 125, and the users 115, 120, and 125 communicate with the provider 110.

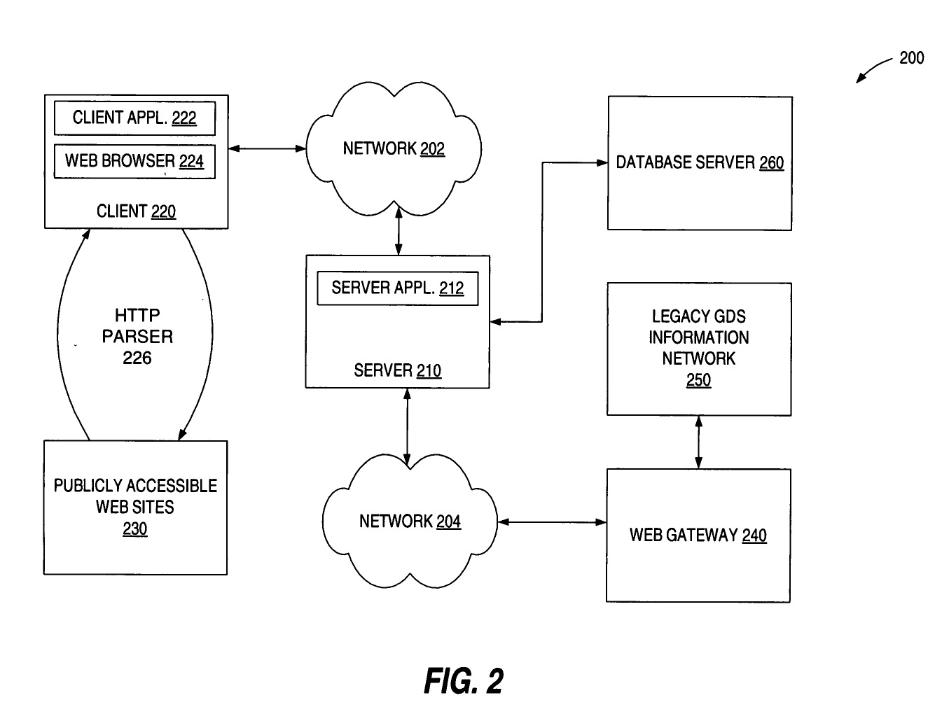

For clarity, FIG. 1A depicts only one provider 110 and one network 105. However, the system 100 may include a plurality of providers and a plurality of networks. Likewise, for clarity, FIG. 1A depicts only three users 115, 120, and 125. However, the IIP system 100 may include a plurality of users. In the discussion below, the user 115 is a representative one of the users 115, 120, and 125. Additional detail of a system for travel fulfillment having multiple nodes and multiple networks is described with reference to FIG. 2.

Each of the provider 110 and the users 115, 120, and 125 includes a respective information processing system (IPS), a subsystem, or a part of a subsystem for executing processes and performing operations (e.g., processing or communicating information) in response thereto, as discussed further below. Each such IPS is formed by various electronic circuitry components. Moreover, as illustrated in FIG. 1A, all such IPS's are coupled to each other. Accordingly, the provider 110 and the users 115, 120, and 125 operate within the network 105.

An IPS is an electronic device capable of processing, executing or otherwise processing information. Examples of an IPS include a server computer, a personal computer (e.g., a desktop computer or a portable computer such as, for example, a laptop computer), or a handheld computer. Additional examples of an IPS may also include a router, a switch and other devices coupled to a network (e.g. the network 105).

Referring now to FIG. 1B, an IPS 130 which is representative of one of the IPS's described above, is illustrated. The IPS 130 may include any or all of the following: (a) a processor 130a for executing and otherwise processing instructions, (b) a plurality of input devices 130b, which are operably coupled to the processor 130a, for inputting information, (c) a display device 130c (e.g., a conventional electronic cathode ray tub (CRT) device or a conventional liquid crystal display (LCD)), which is operably coupled to the processor 130a, for displaying information, (d) a print device 130d (e.g. a conventional electronic printer or plotter), which is operably coupled to the processor 130a, for printing visual images (e.g., textual or graphic information on paper), (e) a computer readable medium 130e, which is operably coupled to the processor 130a, for storing information, as discussed further below, and (f) various other electronic circuitry for performing other operations of the IPS 130 known in the art. It should be understood that the term “information processing system” is intended to encompass any device having a processor that executes instructions from a memory medium.

The IPS 130 includes (a) a network interface (e.g., circuitry) for communicating between the processor 130a and the network 105 and (b) a memory device (e.g., random access memory (RAM) device or read only memory (ROM) device for storing information (e.g., instructions included in a software program executed by processor 130a and data operated upon by processor 130a in response to such instructions)). The communications may occur over wired and/or wireless media. Accordingly the processor 130a is operably coupled to the network 105, the input devices 130b, the display device 130c, the print device 130d, and the computer readable medium 130e, as illustrated in FIG. 1B.

In response to signals from the processor 130a, the display device 130c displays visual images. Information may be input to the processor 130a from the input devices 130b, and the processor 130a may receive such information from the input devices 130b. Also, in response to signals from the processor 130a, the print device 130d prints visual images on paper.

The input devices include a variety of input devices known in the art such as, for example, a conventional electronic keyboard and a pointing device such as, for example, a conventional electronic “mouse”, rollerball, or light pen. The keyboard may be operated to input alphanumeric text information to the processor 130a, and the processor 130a may receive such alphanumeric text information from the keyboard. The pointing device may be operated to input cursor-control information to the processor 130a, and the processor 130a may receive such cursor control information from the pointing device.

The IPS 130 includes an operating system (OS). The OS is a type of software program that controls execution of other software programs, referred to as application software programs. In various embodiments the instructions and/or software programs may be implemented in various ways, including procedure-based techniques, component-based techniques, and/or object-oriented techniques, among others. Examples include assembler, C, XML, C++ objects, Java and Microsoft's .NET technology.

The computer readable medium 130e and the processor 130a are structurally and functionally interrelated with one another as described below in further detail. Each IPS of the illustrative embodiment is structurally and functionally interrelated with a respective computer readable medium, similar to the manner in which the processor 130a is structurally and functionally interrelated with the comptuer readable medium 130e. In that regard, the computer readable medium 130e is a representative one of such computer readable media including, for example, but not limited to, a hard disk drive.

The computer readable medium 130e stores (e.g., encodes, records, or embodies) functional descriptive material (e.g., including but not limited to software (also referred to as computer programs or applications) or data structures). Such functional descriptive material imparts functionality when encoded on the computer readable medium 130e. Also, such functional descriptive material is structurally and functionally interrelated to the computer readable medium 130e.

With such functional descriptive material, data structures define structural and functional interrelationships between such data structures and the computer readable medium 130e (and other aspects of the system 100). Such interrelationships permit the data structures' functionality to be realized. Also, within such functional descriptive material, computer programs define structural and functional interrelationships between such computer programs and the computer readable medium 130e (and other aspects of the system 100). Such interrelationships permit the computer programs' functionality to be realized.

For example, the processor 130a reads (e.g., accesses or copies) such functional descriptive material from the computer readable medium 130e onto the memory device of the IPS 130, and the IPS 130 (more particularly, the processor 130a) performs its operations (as described elsewhere herein) in response to such material which is stored in the memory device of the IPS 130. More particularly, the processor 130a performs the operation of processing a computer application (that is stored, encoded, recorded, or embodied on a computer readable medium) for causing the processor 130a to perform additional operations (as described elsewhere herein). Accordingly, such functional descriptive material exhibits a functional interrelationship with the way in which processor 130a executes its processes and performs its operations.

Further, the computer readable medium 130e is an apparatus from which the computer application is accessible by the processor 130a, and the computer application is processable by the processor 130a for causing the processor 130a to perform such additional operations. In addition to reading such functional descriptive material from the computer readable medium 130e, the processor 130a is capable of reading such functional descriptive material from (or through) the network 105 which is also a computer readable medium (or apparatus). Moreover, the memory device of the IPS 130 is itself a computer readable medium (or apparatus).

FIG. 2 is a block diagram illustrating a travel fulfillment system 200, according to an embodiment. In the depicted embodiment, the travel fulfillment system 200, which is also referred to as a TripStalker system, is a client/server application which continually and constantly searches multiple sources for an optimum price on air fares, lodging costs, rental car fees and/or other travel services. The travel fulfillment system 200 includes a plurality of networks with each network having a plurality of nodes, thereby forming a distributed and completely extensible system for making on-line travel reservations. As is well known, extensibility of a system refers to the ability of the system to expand without substantially affecting the installed components. In a particular embodiment, the travel fulfillment system 200 is extensible by using an object-oriented framework such as an extensible markup language (XML) which provides extensibility through encapsulation, polymorphism, and late binding.

The processes described herein may be accomplished through a combination of existing Internet and computing standards such as web services, XML Publish/Response technology, windows services and/or scheduling (“cron”) jobs, object oriented data repositories and RDBMS's (Relational Database Management Systems).

As described earlier, web services are a standardized method of integrating web-based applications over the Internet. Used primarily as a means for businesses and/or applications to communicate with each other and with clients, web services allow organizations to communicate data without intimate knowledge of each other's information technology (IT) systems behind the firewall. Unlike traditional client/server models, such as a web server/web page system, web services generally do not provide the user with a graphical user interface (GUI). Web services instead share business logic, data and processes through a programmatic interface across a network such as the network 105. The applications interface directly with each other, while the users generally do not. Developers may then add the web service to a GUI (such as a web page or an executable program) to offer specific functionality to users. Web services do not require the use of browsers and/or HTML. Additionally, web services enable different applications from different sources to communicate with each other without time-consuming custom coding. Since all communication is in XML standard, web services are platform independent and not tied to any one operating system and/or programming language. For example, Java can talk with Perl, Windows applications can talk with UNIX applications.

In the depicted embodiment, the travel fulfillment system 200 includes a server 210 coupled to a client 220 via a network 202. In a particular embodiment, the network 202 is substantially the same as the network 105, the client 220 is substantially the same as the user 115 and the server 210 is substantially the same as the provider 110 as described with reference to FIGS. 1A and 1B. The client 220 is operable in a stand alone mode that is independent of the operating status of the server 210. Similarly, the server 210 is operable in a stand alone mode that is independent of the operating status of the client 220. Thus, the client 220 and the server 210 are configurable to operate concurrently and co-operatively but independently of each other.

A TripStalker client application 222 is installed and operable to execute on the client 220. The TripStalker client application 222 may be downloaded from the server 210 via the network 202 and/or may loaded directly via a digital distribution media such as an optical disc. In a particular embodiment, the client 220 includes a web browser 224 and a graphical user interface software (not shown) for ease of access and ease of navigation to perform various functions.

For travel fulfillment, a user launches the TripStalker client application 222 to configure a plurality of criteria, which define desired conditions for travel. The plurality of criteria may be selectable from a list of criteria, defining various travel related attributes such as personal, price, place and time for the travel fulfillment. For example, the list of criteria may include number of persons traveling, ages of the travelers, city of origin, city of destination, desired time of departure, desired time of arrival, maximum total time of travel, maximum number of connections, availability of a preferred seat/car size, and similar others. In a particular embodiment, a user may input one or more criteria for defining the optimum price such as the lowest price within the published prices and/or a maximum price the consumer is willing to pay for the travel fulfillment.

The TripStalker client application 222 and hence the client 220 is configured to interact directly with publicly accessible travel related web sites 230 via the Internet, such as the network 202, using a web browser 224. The publicly accessible web sites 230, which may be described as selectable nodes of the network 202, are Internet web sites that may be accessed by any member of the public logged on to the Internet via the client 220 to make a travel reservation and/or obtain travel information. In a particular embodiment, the client 220 interacts with the publicly accessible travel related web sites 230 using the web browser 224 and a HTTP parser 226. Examples of well known travel providers that operate the publicly accessible travel related web sites 230 includes airlines such as American Airlines, car rental companies such as Hertz and hotel chains such as Starwood Hotels and similar others. It is the objective of the respective operators of each of the publicly accessible travel related web sites 230 to deal directly with potential travelers for making the travel reservations without having to go through an intermediary.

In a particular embodiment, the TripStalker client application 222 is configured to continually and constantly search the publicly accessible travel related web sites 230 for published prices fulfilling the plurality of criteria. Results of the search may be communicated to the server 210 at periodic intervals and/or upon detecting a change in the published prices. In an embodiment, the client 220 interacts with the server 210 using web services.

In the depicted embodiment, the client 220 interacts with the server 210 using web services to co-operatively perform additional functions such as: 1) authentication of user logins to verify/authenticate authorized subscribers of the TripStalker client application 222, 2) reporting information gathered by the client 220 such as results of the continual searches for the published prices and/or updates to the plurality of criteria, 3) querying the server 210 for an optimum price for entered plurality of criteria, 4) checking for software updates, 5) checking for configuration file updates modifying behavior of the client 220, thereby making the travel fulfillment system 200 extensible, 6) checking for messages to be displayed to the user, and 7) similar others.

In the depicted embodiment, the server 210 is coupled to a web gateway 240 via a network 204 for accessing additional travel providers. The server 210 is also directly coupled to a TripStalker database server 260, which serves as a repository for storing data pertaining to the travel fulfillment system 200. In a particular embodiment, the web gateway 240 is substantially the same as the provider 115 and the network 204 is substantially the same as network 105 described with reference to FIGS. 1A and 1B. In an embodiment, the server 210 interacts with others server such as the web gateway 240 and the client 220 using web services.

The task of continual searching or stalking the Internet for locating published prices fulfilling the plurality of criteria is shared co-operatively between the server 210 and the client 220. A TripStalker server application 212 is installed and operable to execute on the server 210 and work co-operatively with the TripStalker client application 222. Using the same plurality of criteria established by the user, the TripStalker server application 212 is configured to continually and constantly search alternate web sites via the web gateway 240, which may not be easily and readily accessible as the publicly accessible web sites 230, for locating published prices fulfilling the plurality of criteria.

Results of the search may be communicated to the TripStalker database server 260 at periodic intervals and/or upon detecting a change in the published prices. Thus, published pricing information collected by the the TripStalker server application 212 and the TripStalker server application 212 is integrated by the server 210 and stored into the TripStalker database server 260. In a particular embodiment, data within the travel fulfillment system 200 may be stored in a relational database management system (RDBMS) technology supporting SQL queries. The TripStalker database server 260 may be queried by the client 220 via the server 210 and/or by the server 210 to determine the optimum price, e.g., by determining the lowest price from all the published prices. In a particular embodiment, the TripStalker database server 260 may be combined with the server 210 for cost considerations.

In the depicted embodiment, the web gateway 240 provides a published web interface for interacting with the alternate web sites, which include additional on-line travel data resources such as Global Distribution Systems (GDS). The web gateway 240 thus provides access to the alternate web sites, which may be different than the publicly accessible web sites 230, and which may not be generally accessible to the general public for making a travel reservation and/or for obtaining travel information. The GDS network includes travel providers such as Amadeus, Galileo, Sabre and Worldspan reservation systems and regional providers such as SITA's Sahara, Infini (Japan), Axess (Japan), Tapas (Korea), Fantasia (South Pacific), and Abacus (Asia/Pacific). In a particular embodiment, the web gateway 240 interacts with a legacy GDS reservation network 250 to enable access to legacy data sources that may pre-date the availability of the Internet. In a particular embodiment, the web gateway 240 may include additional travel inventory fulfillment providers including affiliate partners (such as IAN/TravelNow.com, Hotels.com), Travel Consolidators, Travel Bucket Buy Shops, and similar others. Generally the operators of these systems/web sites may require user authentication based on single IP address and/or other authorization to connect to, search and fulfill through these services.

In a particular embodiment, the server 210 interacts with the web gateway 240 using web services and XML Publish/Response technology. In an embodiment, the server 210 uses HTTP POST to send a XML query to price a trip itinerary. The web gateway 240 returns a XML response to the HTTP POST with trip/price details. If the price meets user defined criteria and/or user indicates an approval to purchase the travel reservation then the server 210 sends payment information and authorization to book travel. The web gateway 240 returns a XML response to the booking request with a booking confirmation.

In an embodiment, the server 210 may be configured for the travel fulfillment, e.g., to book the travel itinerary meeting the users criteria, through the same systems that it searches, e.g., an airline website. This enables the user to interact directly with the inventory supplier after the order has been placed. The travel fulfillment system 200 may simply attach a booking fee at the time booking occurs. In an alternate embodiment, the travel fulfillment system 200 may also operate under a subscription fee model. The user may set either a notify price or a booking price. These criteria instruct the travel fulfillment system 200 to either notify the user or automatically book the trip based on the user's criteria.

In a particular embodiment, the server 210 may be implemented as a cluster of servers. Additionally, the server 210 may separate web services for each discreet piece of functionality. For example, the server 210 may dedicate separate web services for performing separate hotel, car rental and air. Similarly, dedicated web services may be established for client services such as: login authentication, checking for updates to the client and checking for configuration changes. New web services may be added and deployed on the TripStalker servers and the installed client applications may be automatically updated to use these web services the next time the TripStalker client application 222 checks for an update and/or configuration change, which may programmed to do at regular intervals. By allowing for installed applications to modify their behavior based on data fed to the applications from the servers, the travel fulfillment system 200 is advantageously able to modify and adapt its behavior as the methods to query for travel inventory change over time.

Unlike traditional ‘meta search engines’ and/or ‘online booking service’ the travel fulfillment system 200 advantageously utilizes a client/server architecture to continually search over time, thereby ‘stalking’ the trip itineraries entered into it. This resulting desktop travel agent has the ability to accept a large variation in the number and types of parameters from the user to select which trips it should notify the user or automatically book for the user as the user has selected. For example, a user may wish to fly on American Airlines, have the ticket booked under a specific price at aa.com web site on flights that leave from 8 am to 10 am with less than 6 hour duration and have an aisle seat available. This is illustrative of the level of detail a user may set up to configure the plurality of criteria. As an alternative, users may simply enter the originating city, the destination city and the specific travel dates.

The travel fulfillment system 200 is an integrated system using a combination of distributive computing and server-side centralization to empower the end user to store desired travel itineraries and have the system automatically and continuously search any and all fulfillment services to the greatest degree of detail enabled by the system for the user's specific travel criteria.

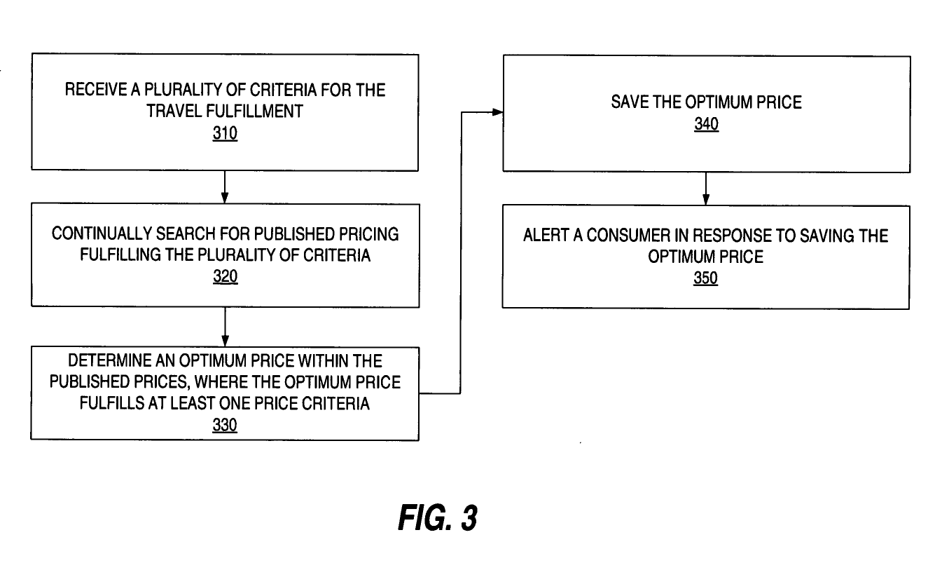

FIG. 3 is a flow chart illustrating a method for providing travel fulfillment, according to an embodiment. In a particular embodiment, the method for the providing travel fulfillment is implemented using the travel fulfillment system 200 described with reference to FIG. 2. In step 310, a plurality of criteria for the travel fulfillment is received. In step 320, published prices fulfilling the plurality of criteria are continually searched during a time interval defined in the plurality of criteria. At step 330, an optimum price is determined within the published prices when the optimum price fulfils at least one price criteria defined by the user. At step 340, the optimum price is saved for later use.

Various steps described above may be added, omitted, combined, altered, or performed in different orders. In a particular embodiment, step 350 may be added to alert a consumer in response to saving the optimum price.

Although illustrative embodiments have been shown and described, a wide range of modification, change and substitution is contemplated in the foregoing disclosure and in some instances, some features of the embodiments may be employed without a corresponding use of other features. Those of ordinary skill in the art will appreciate that the hardware and methods illustrated herein may vary depending on the implementation. It is important to note that while the present invention has been described in the context of a computer system having a processor and memory, those of ordinary skill in the art will appreciate that the processes of the present disclosure are capable of being distributed as computer readable medium of instructions in a variety of forms and that the present disclosure applies equally regardless of the particular type of signal bearing media actually used to carry out the distribution. Examples of computer readable media may include recordable-type media such a floppy disc, a hard disk drive, a RAM, optical media such as CD's and DVD's, and transmission-type media such as digital and/or analog communications links. As an additional example, it should be understood that while the disclosure described continual searching for travel fulfillment, it would be within the spirit and scope of the disclosure to encompass an embodiment deploying a web based application continually searching for any product and/or service having web based published prices in accordance with user defined criteria.

The methods and systems described herein provide for an adaptable implementation. Although certain embodiments have been described using specific examples, it will be apparent to those skilled in the art that the invention is not limited to these few examples. The benefits, advantages, solutions to problems, and any element(s) that may cause any benefit, advantage, or solution to occur or become more pronounced are not to be construed as a critical, required, or an essential feature or element of the present disclosure.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method for providing travel fulfillment, the method comprising:
receiving a plurality of criteria for the travel fulfillment;
searching for published prices fulfilling the plurality of criteria, wherein the searching for the published prices occurs continually during a time interval included in the plurality of criteria;
determining an optimum price within the published prices, wherein the optimum price fulfils at least one price criteria; and
saving the optimum price.

2. The method of claim 1, wherein the searching is shared between a client and a server coupled by a network, wherein the searching by the client and the server occurs concurrently and independently.

3. The method of claim 2, wherein the client searches for the published prices at publicly accessible web sites, wherein the publicly accessible web sites are enabled to provide the travel fulfillment in accordance with the plurality of criteria.

4. The method of claim 2, wherein the server searches for the published prices at alternate web sites that are different than the publicly accessible web sites, wherein the publicly accessible web sites and the alternate web sites are enabled to provide the travel fulfillment in accordance with the plurality of criteria.

5. The method of claim 4, wherein the alternate web sites provide access to at least one of Amadeus, Galileo, Sabre and Worldspan reservation systems.

6. The method of claim 1, wherein the publicly accessible web sites are operable by travel providers intending to sell travel services directly to consumers.

7. The method of claim 1, wherein the plurality of criteria are selectable from a list of criteria, wherein the list of criteria define personal, price, place and time attributes for the travel fulfillment.

8. The method of claim 1, wherein the time interval is configurable to start from configuration of the plurality of criteria and ending with an event indicative of the travel fulfillment.

9. The method of claim 1, wherein the at least one price criteria is lowest price.

10. The method of claim 1, wherein the optimum price is saved in a database.

11. The method of claim 1 further comprising:
alerting a consumer in response to saving the optimum price.

12. The method of claim 1, wherein the travel fulfillment includes completing a travel reservation for at least one of an airline, a hotel, a car rental and a cruise, wherein the travel reservation provides the optimum price.

13. The method of claim 12, wherein the travel reservation providing the optimum price is booked at a web site of a provider offering the optimum price.

14. A travel fulfillment system, the system comprising:
a network;
a client having a web browser, the client being coupled to the network, wherein the client is operable to execute a client application program for travel fulfillment, wherein the client application program is executable to configure a plurality of criteria for the travel fulfillment, wherein the client application program continually searches selectable nodes of the network for published prices fulfilling the plurality of criteria; and
a server coupled to the client via the network, wherein the server is operable to execute a server application program to continually search alternate selectable nodes of the network for the published prices fulfilling the plurality of criteria, wherein the server application program and the client application program work co-operatively to determine an optimum price within the published prices, wherein the optimum price fulfils at least one price criteria.

15. The system of claim 14, wherein the alternate selectable nodes provide access to at least one of Amadeus, Galileo, Sabre and Worldspan reservation systems.

16. The system of claim 14, wherein the selectable nodes are publicly accessible web sites, the web sites being operated by travel providers intending to sell travel services directly to consumers.

17. The system of claim 14, the continual searching occurs during a time interval that is configurable to start from configuration of the plurality of criteria and ending with an event indicative of the travel fulfillment.

18. A computer readable medium for providing travel fulfillment, the computer readable medium having instructions for causing a computer system to execute a method comprising:
receiving a plurality of criteria for the travel fulfillment;
searching for published prices fulfilling the plurality of criteria, wherein the searching for the published prices occurs continually during a time interval included in the plurality of criteria;
determining an optimum price within the published prices, wherein the optimum price fulfils at least one price criteria; and
saving the optimum price.

19. The computer readable medium of claim 18, wherein the searching is shared between a client and a server coupled by a network, wherein the searching by the client and the server occurs concurrently and independently.

20. The computer readable medium of claim 18, wherein the travel fulfillment includes completing a travel reservation for at least one of an airline, a hotel, a car rental and a cruise, wherein the travel reservation provides the optimum price.
